(19) United States
(12) Patent Application Publication
(10) Pub. No.: US 2002/0066314 A1
(43) Pub. Date: Jun. 6, 2002

(54) Fill level gauge

(76) Inventor: Wilhelm Lubbers, Borger (DE)

Correspondence Address: CESARI AND MCKENNA, LLP, 88 BLACK FALCON AVENUE, BOSTON, MA, 02210, US

(21) Appl. No.: 09/991,760

(22) Filed: Nov. 23, 2001

(30) Foreign Application Priority Data
Dec. 1, 2000 (DE) 100 60 068.9

(51) Int. Cl. G01F 23/00

(52) U.S. Cl. 73/290 R; 324/637

(57) ABSTRACT

A fill level gauge, operating by the radar principle and preferably used for measuring the fill level of a fluid in a container, incorporates a microwave generator for generating a microwave signal, a waveguide for conducting the microwave signal, a horn radiator serving as a transmitting and/or receiving antenna, and a connecting flange, wherein the horn radiator is positioned on the side of the connecting flange that faces the fluid. The spatial, physical separation and the microwave-conducting connection of the waveguide relative to the horn radiator are provided by a transmission plate which is mounted in the horn radiator in tight, pressure-sealing fashion. The result is an easily implementable physical isolation and microwave-conducting connection of the waveguide relative to the horn radiator by means of a transmission plate without the need for the installation of a separate microwave window.

### BACKGROUND OF THE INVENTION

1. Field of the Invention

This invention relates to a fill level gauge, employing the radar principle, preferably for measuring the fill level of a fluid in a container, incorporating a microwave generator for generating a microwave signal, a waveguide for conducting the microwave signal, a horn radiator functioning as a transmitter and/or receiver, and a connecting flange, wherein said horn radiator is positioned on the side of the connecting flange that faces the fluid. A fill level gauge of this type has been described in the German utility patent 94 12 243.

2. Background Information

For some time, apart from the traditional mechanical fill level gauges which employ a float or feeler plate, fill level gauges have been on the market which are based on a principle whereby an oscillator transmits oscillatory waves, an oscillation detector captures the oscillations that are reflected by the surface of a fluid in a container, and the detected runtime of the oscillatory waves serves as a measure for computing the fill level of the fluid in the container. In this connection, reference is made to the German patent disclosures 42 33 324, 43 27 333 and 44 19 462.

Fill level gauges of the type mentioned above are generally referred to as non-contact level gauges since neither the oscillators nor the oscillation detectors nor the transmitting or receiving antenna need to be in physical contact with the fluid. In any event, the transmitting antenna and the receiving antenna do not touch the fluid unless the container is overfilled.

All of these earlier, generally non-contact fill level gauges work with internally transmitted oscillatory waves which are reflected by the surface of the fluid whose level is to be measured. Among these conventional fill-level detection methods one differentiates between those which measure the phase shift between the transmitted oscillation waves and the reflected waves as they are detected, and those which directly measure the runtime of the oscillatory waves. In turn, runtime measuring systems are essentially broken down into fill level gauges which measure the runtime on the basis of oscillation waves with pulse-modulated amplitudes versus those which measure the runtime on the basis of frequency-modulated oscillation waves. The latter are also known as FMCW-type fill level gauges.

The non-contact fill level gauges to be addressed, employing the radar principle, typically use a horn radiator as their transmitting and/or receiving antenna. The microwave signal emanating from a microwave generator is usually fed to the horn radiator via a waveguide. For spatial separation, i.e. physical isolation, and for the microwave link between the waveguide and the horn radiator, the approach to date has been to use a microwave window as described for instance in the German patent disclosure 195 42 525. A microwave window of that type is attached with its frame on the far side of the mounting flange away from the fluid in such fashion as to create a pressure-sealed connection between the microwave window and the mounting flange. This physically separates the waveguide and the microwave generator from what may be a chemically aggressive and/or corrosive fluid in the container. It does, however, require the installation of an added component, that being the microwave window. If no such microwave window is provided, the waveguide and the microwave generator are vulnerably exposed to the aggressive and/or corrosive fluid.

### SUMMARY OF THE INVENTION

It is therefore the objective of this invention to provide a fill level gauge, operating by the radar principle, which at all times and in simple fashion ensures a pressure-sealed physical separation of both the waveguide and the microwave generator from the fluid in the container.

The fill level gauge according to this invention, designed to solve the aforementioned problem and based on the level-gauge concept described above, is characterized in that it provides for the physical isolation of the waveguide from the horn radiator and its microwave-conducting connection with the latter by means of a transmission plate which is mounted in the horn radiator in pressure-sealing fashion. The design according to this invention thus eliminates the separate microwave window and instead provides for a horn radiator which itself incorporates an integrated transmission plate for the physical isolation of the waveguide from, and its microwave connection with, the horn radiator. This eliminates the possibility of an accidental omission of the microwave window.

Transmission-plate materials capable of conducting microwaves essentially include glass and ceramics. The transmission plate may be of any shape but should preferably be round or, more specifically, circular.

There are many ways to mount the transmission plate in the horn radiator so as to provide a pressure seal. However, in a preferred embodiment of the invention, the horn radiator is coated with a dielectric layer by way of which the transmission plate is fused or glued into the horn radiator. It follows that in this preferred configuration of the invention the surface of the horn radiator is coated with the dielectric at least in the area where the transmission plate is mounted in the horn radiator. This means that the transmission plate is not in direct contact with the horn radiator proper but is connected to the latter in indirect fashion via the isolating dielectric. The indirect connection is established either by gluing the transmission plate into the horn radiator using an isolating cement or by fusing it into the dielectric layer. For the fusion-mounting process both the edge of the dielectric and the edge of the transmission plate must be melted, or both the dielectric and the transmission plate are fused onto the horn radiator in one simultaneous operation. That process results in the physical isolation and microwave-conducting connection of the waveguide relative to the horn radiator in such fashion that the horn radiator supports the transmission plate virtually without subjecting it to any mechanical stress or force.

For fusing or gluing the transmission plate into the horn radiator via the dielectric, as described above, it suffices to coat the horn radiator with a dielectric layer only in the area where it borders on the integrated transmission plate. However, in one preferred implementation of the invention, the entire surface of the horn radiator is coated with the dielectric. This ensures particularly effective protection of the horn radiator against any chemically aggressive and/or corrosive fluid in the container.

When coating the horn radiator with the dielectric, the thickness of the dielectric layer should not exceed 2 mm since otherwise the dielectric might be charged up to a point where it no longer meets established explosion protection standards. The preferred materials for the dielectric layer include enamel as well as plastics such as PTFE, PFA, FEP or PVDF.

It is especially when enamel is used as the dielectric, and especially when the horn radiator is completely coated with an enamel layer, that stress-free mounting of the transmission plate in the horn radiator proves particularly beneficial insofar as any chipping of the enamel layer is highly unlikely, given that the transmission plate is glued or fused into the horn radiator without any stress, pressure or force applied. Where the transmission plate used consists of glass, its installation requires the enamel-coated horn radiator to be heated to a point where the enamel begins to melt, allowing the transmission glass plate to be set in the soft enamel. As the enamel cools off, a mechanically solid and tight connection is established.

In a preferred embodiment of the invention, both the physical separation and the microwave-conducting connection can be further improved in terms of microwave transmissivity by selecting a thickness for the transmission plate that is a multiple integer of the wavelength of the microwaves. Of course, when the thickness of the transmission plate is adapted in that manner, the dielectric number of the transmission-plate material and the propagation rate of the microwave radiation within the waveguide and horn radiator must be factored in.

The design according to this invention may be further enhanced by increasing the microwave transmissivity of the physically isolating, microwave-conducting connection between the waveguide and the horn radiator, for which purpose the characteristic wave impedance of the transmission plate is adapted to the wave impedance of the waveguide and the horn radiator by means of at least one unitized adapter integrated with the transmission plate. The integrated, single-unit inclusion of the adapter in the transmission plate eliminates any transitions between the transmission plate and the adapter, thus avoiding microwave reflection that would otherwise be inevitable at such transition points next to the transmission plate, while at the same time eliminating any intermediate spaces between the transmission plate and the adapter which would be susceptible to the penetration of chemically aggressive and/or corrosive substances.

When the fill level gauge is to be used in situations where there is a particularly high pressure differential between the interior of the container and the area outside the container, i.e. where the transmission plate is exposed on one side to significant positive or negative pressure, a preferred embodiment of the invention provides for the transmission plate to be held in place in the horn radiator in an axial direction by means of a positive form-fit. The fact that, as part of this invention, the transmission plate is held in place at least in one axial direction within the horn radiator by virtue of positive, form-fitting friction means that, in addition to the tight glue or fusion mount, another provision is included that prevents the transmission plate from popping out of the horn radiator due to a high prevailing pressure differential. In the embodiment concerned, according to this invention, this is accomplished by providing a contour-matched support shoulder in the horn radiator which prevents any movement of the transmission plate along the pressure vector.

Specifically, an embodiment of this type in the fill level gauge according to the invention is made feasible for instance by means of a circular transmission plate whose side that is supported in form-fitting fashion within the horn radiator has a smaller diameter than its opposite side. The side of the transmission window that is exposed to the higher pressure is the one with the larger diameter. In particular, the transmission plate could be either conical or it could have a stepped rim. Either way, the area of the horn radiator that serves to hold the transmission plate and which may be coated with a dielectric layer, is so contoured as to match the shape of the transmission plate.

### BRIEF DESCRIPTION OF THE DRAWING

There are numerous ways in which the design of the fill level gauge according to this invention can be implemented and further enhanced. In this context, reference is made to the dependent claims and to the following detailed description explaining preferred embodiments of the invention with the aid of the drawings, in which:

FIG. 1 is an exploded cross-sectional view of a first, preferred embodiment of an antenna system of a fill level gauge according to this invention;

FIG. 2 is a cross-sectional view of the assembled antenna system of the first, preferred embodiment of the fill level gauge according to this invention;

FIG. 3 is a cross-sectional view of an antenna system of a second preferred design example of the fill level gauge according to this invention, and

FIG. 4 is a cross-sectional view of an antenna system of a third preferred embodiment of the fill level gauge according to this invention.

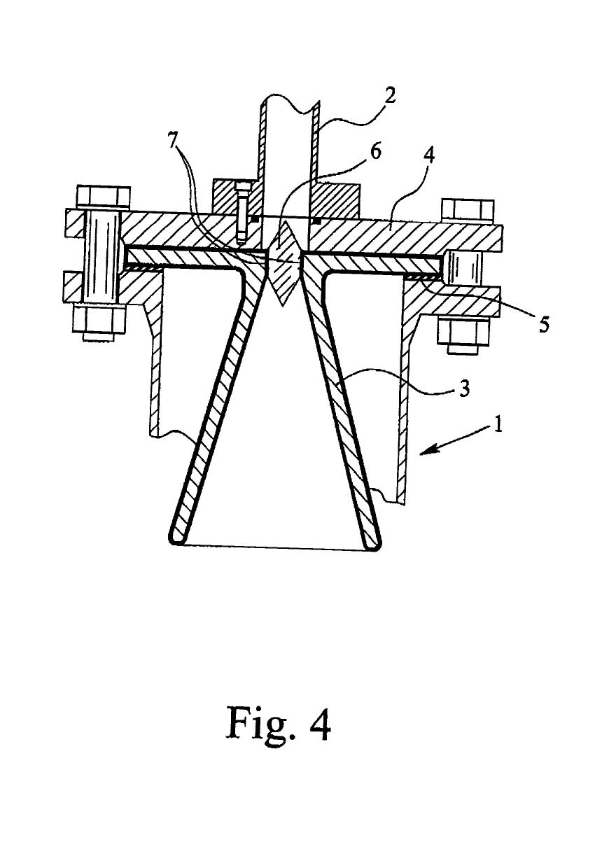

### DESCRIPTION OF THE PREFERRED EMBODIMENTS

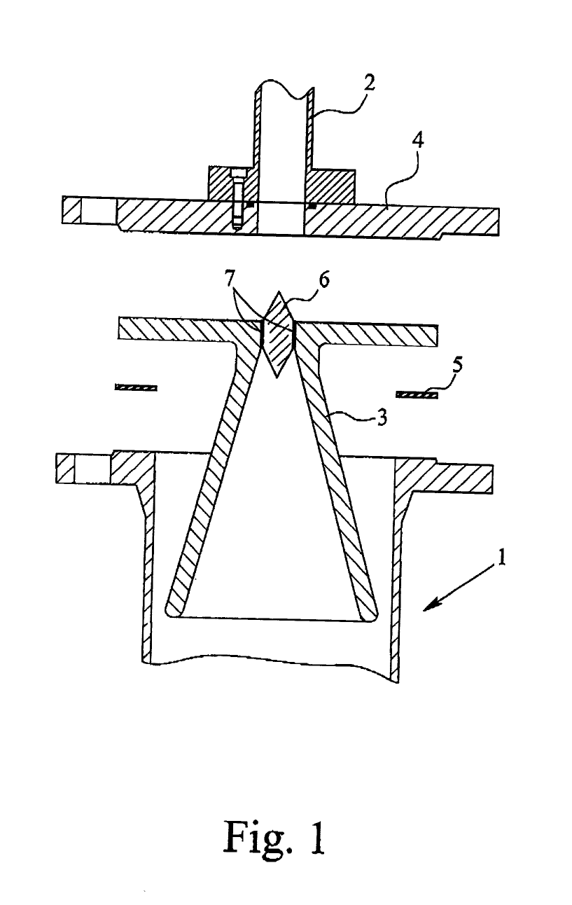

FIG. 1 shows the part of a fill level gauge according to a first preferred embodiment of the invention which is a significant element of the latter, that being the antenna system of the fill level gauge to be mounted on a container. The illustrations in FIG. 1 and in the other figures do not include a microwave generator that transmits microwave signals in the fill level gauge or a measuring transducer that receives the reflected microwave signals.

As depicted in the figures, the fill level gauge according to this invention incorporates a waveguide 2 into which the microwave signal emanating from the microwave generator is coupled and which conducts the microwave signal. The fill level gauge also incorporates a horn antenna or radiator 3 which consists of a special stainless steel and which, in the preferred embodiments of the invention here illustrated, serves as a dual-purpose transmitting and receiving antenna. Also provided are a connecting flange 4 and a gasket 5, said gasket 5 serving to establish a seal between the horn radiator 3 and the container 1. The waveguide 2 carries the microwave signal emanating from the microwave generator toward the connecting flange 4 and, since the horn radiator also functions as a receiving antenna, the waveguide also carries the microwave signal reflected by the fluid and received by the horn radiator 3 back to the measuring transducer, not illustrated. The waveguide 2, extending respectively from the microwave generator and from the measuring transducer, is located on the side of the connecting flange 4 that faces away from the fluid.

FIG. 1 shows that for the spatial, physical separation and microwave-conducting connection of the waveguide 2 with the horn radiator 3 a transmission plate 6 is provided which is installed in the horn radiator 3 in tight, pressure-sealing fashion. In the first preferred embodiment of the invention, illustrated in FIG. 1, the transmission plate 6 is fused into the horn radiator 3. To that effect, the area of the horn radiator 3 that faces and accepts the transmission plate 6 is coated with a dielectric 7 which in this case is an enamel layer.

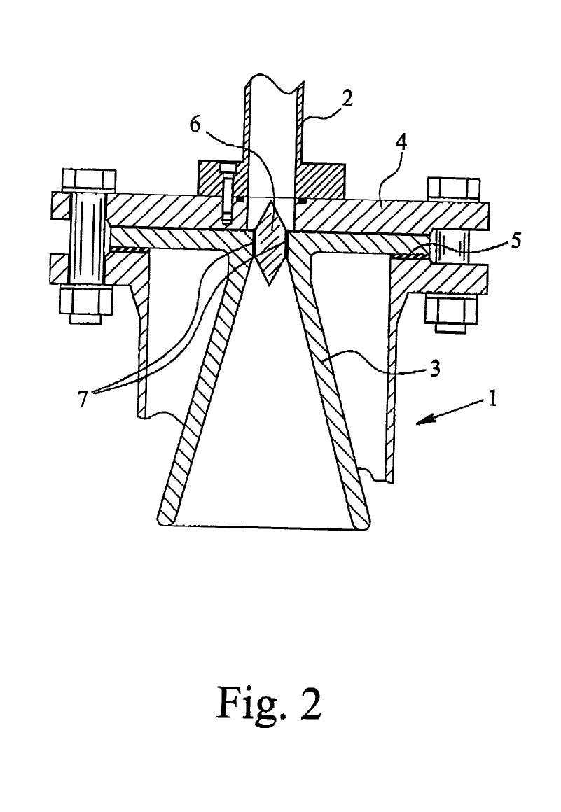

FIG. 2, illustrating the assembled antenna system of the fill level gauge according to the first preferred embodiment of this invention, again shows how the interior of the container 1 is sealed from its outer environment by means of the gasket 5 positioned between the container 1 and the horn radiator 3, and also by the fact that the transmission plate 6 is tightly fitted into the horn radiator 3 via the dielectric 7. In addition, the transmission plate 6 is provided, on its side facing the fluid in the container and on its side facing away from the fluid, with an integrated adapter element which serves to adapt the characteristic wave impedance of the transmission plate 6 to the wave impedance of the waveguide 2 and, respectively, of the horn radiator 3. In the case at hand, the adapters chosen are in the form of essentially conical extensions. Since the transmission plate 6 and the two adapter elements are integrated into one unit, there are no boundary surfaces between the transmission plate 6 and the adapters which might otherwise be susceptible to penetration by chemically aggressive and/or corrosive fluids.

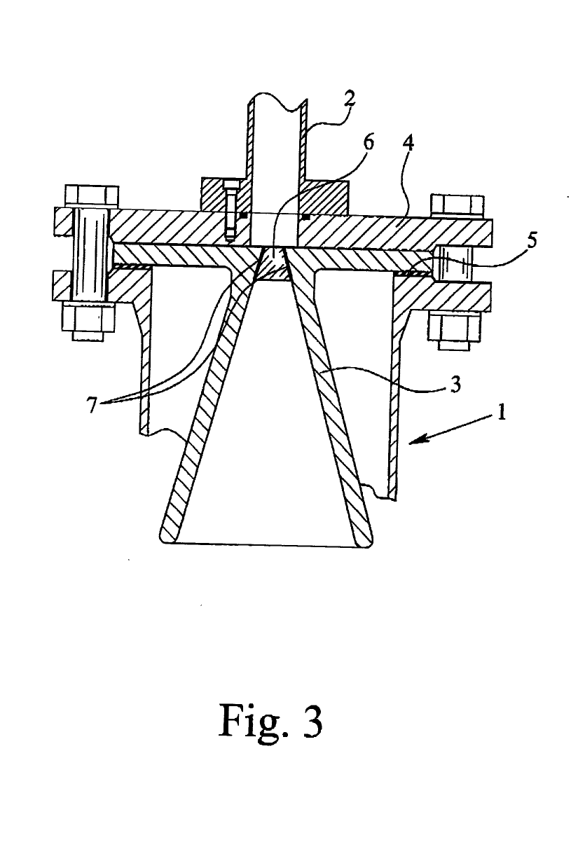

For situations where the pressure in the container 1 is significantly higher than that in adjoining areas, a second preferred embodiment of this invention, illustrated in FIG. 3, provides for a transmission plate 6 which in its axial direction is held in place in form-fitting, friction-mounted fashion within the horn radiator 3. Specifically, the transmission plate 6 in the second preferred embodiment of this invention is tapered, i.e. conical. In the area accepting the conical transmission plate 6, the horn radiator 3 is correspondingly shaped to match the contour of the transmission plate 6. The transmission plate 6 is so tapered that its side with the larger diameter faces the fluid while its side with the smaller diameter faces the connecting flange 4, so that even when the pressure in the container 1 is very high, the transmission plate 6 cannot be pushed out of the horn radiator 3. On the contrary, as the pressure differential between the inside and the outside of the container 1 increases, the augmented pressure enhances the sealing action between the transmission plate 6 and the horn radiator 3.

While in the antenna systems according to the first preferred embodiment of the invention and also in the second preferred embodiment of the invention, the horn radiator 3 is coated with a dielectric 7 only in the area accepting the transmission plate 6, a third preferred embodiment of the invention provides for the entire surface of the horn radiator 3 to be coated with a dielectric layer 7. This serves to protect the horn radiator 3 in its entirety against the effects of a chemically aggressive and/or corrosive substance. In this case, the dielectric 7 is again in the form of an enamel layer. The thickness of that layer must not exceed 2 mm, since otherwise an electrical charge might build up on the surface of the horn radiator 3, of a magnitude that would not be permissible in light of existing explosion protection regulations.

1. A fill level gauge, operating by the radar principle and preferably used for measuring the fill level of a fluid in a container, incorporating a microwave generator for generating a microwave signal, a waveguide for conducting said microwave signal, a horn radiator serving as a transmitting and/or receiving antenna, and a connecting flange, said horn radiator being positioned on the side of the connecting flange that faces the fluid, wherein for the spatial separation and the microwave-conducting connection of the waveguide relative to the horn radiator, a transmission plate is provided which is installed in the horn radiator in tight, pressure-sealing fashion, the horn radiator being coated with a dielectric layer and the transmission plate is fused or glued into the horn radiator through the intermediary of said dielectric layer.

2. The fill level gauge as in claim 1, wherein the entire surface of the horn radiator is coated with the dielectric layer.

3. The fill level gauge as in claim 1 or 2, wherein the maximum thickness of the dielectric layer is 2 mm.

4. The fill level gauge as in claim 1 or 2, wherein the dielectric layer consists of an enamel material.

5. The fill level gauge as in claim 1 or 2, wherein the dielectric layer consists of a plastic material, preferably PTFE, PFA, FEP or PVDF.

6. The fill level gauge as in one of the claim 1 or 2, wherein the thickness of the transmission plate corresponds to a multiple integer of the wavelength of the microwaves.

7. The fill level gauge as in claim 1 or 2, characterized in that, for adapting the wave impedance of the transmission plate to the wave impedance of the waveguide and, respectively, of the horn radiator, the transmission plate is provided with at least one integrated adapter element.

8. The fill level gauge as in claim 1 or 2, wherein, at least in one direction of its normal axis, the transmission plate is held in place in the horn radiator by means of a positive form-fitting countersupport.

9. The fill level gauge as in claim 8, wherein the transmission plate is circular in shape and that its diameter on the side on which it is held in place by the form-fitting countersupport is smaller than its diameter on the opposite side.

10. The fill level gauge as in claim 8, wherein the transmission plate is cone-shaped.

11. The fill level gauge as in claim 8, wherein the transmission plate is provided with a stepped rim.
